(19) United States
(12) Patent Application Publication
(10) Pub. No.: US 2007/0219323 A1
(43) Pub. Date: Sep. 20, 2007

(54) Polyester strands, production thereof and use thereof

(76) Inventor: Hans-Joachim Bruning, Augsburg (DE)

Correspondence Address: FERRELLS, PLLC, P. O. BOX 312, CLIFTON, VA, 20124-1706, US

(21) Appl. No.: 11/724,138

(22) Filed: Mar. 14, 2007

(30) Foreign Application Priority Data
Mar. 16, 2006 (DE) DE102006012048.5

(51) Int. Cl. C08L 67/03; D02G 3/00

(52) U.S. Cl. 525/444; 528/300; 528/308; 528/308.7; 528/302; 428/364

(57) ABSTRACT

Melt-spun strands comprising (a) a thermoplastic and elastomeric polyester copolymer comprising structural repeat units derived from different diols, of which one is a polyetherdiol, and (b) a thermoplastic polyester copolymer comprising structural repeat units derived from different dicarboxylic acids or their polyester-forming derivatives. The strands possess excellent abrasion resistance coupled with high dimensional stability and are useful for producing screens or other technical/industrial fabrics.

### CLAIM FOR PRIORITY

This application is based upon German Patent Application No. DE 10 2006 012 048.5, entitled, “Polyesterfaden,Verfahren zu deren Herstellung und deren Verwendung”, filed Mar. 16, 2006. The priority of German Patent Application No. DE 10 2006 012 048.5 is hereby claimed and its disclosure incorporated herein by reference.

### TECHNICAL FIELD

The present invention concerns polyester compositions processable into strands having very high abrasion resistance and dimensional stability. These strands, which are preferably monofilaments, are useful, for example, in screens or conveyor belts.

### BACKGROUND OF THE INVENTION

It is known that polyester fibers used in industrial applications are in most cases subjected to high mechanical and or thermal stressors in use. In addition, in many cases the fibers are stressed due to chemical and other ambient influences, to which the material has to offer adequate resistance. In addition to having adequate resistance to all these stressors, the material has to possess good dimensional stability and exhibit constant stress-strain properties over very long use periods.

One example of industrial applications where monofilaments are subject to a combination of high mechanical, thermal and chemical stresses is in filter applications, screens, or conveyor belts. These uses require monofilaments having excellent mechanical properties, such as high initial modulus, breaking strength, knot strength, loop strength and also high abrasion resistance coupled with high hydrolysis resistance in order that they may withstand high stresses encountered in their use and in order that the screens or conveyor belts may have an adequate use life.

Industrial manufacturers, such as paper makers or processors, utilize filters or conveyor belts in operations taking place at elevated temperatures and in hot moist environments. Polyester-based manufactured fibers have a proven record of good performance in such environments, but when used in hot moist environments polyesters are vulnerable to mechanical abrasion as well as hydrolytic degradation.

Abrasion can have a wide variety of causes in industrial uses. For instance, the sheet-forming wire screen in papermaking machines dewaters paper slurry which is pulled over suction boxes, and this results in enhanced wear of the wire screen. At the dry end of the papermaking machine, wire screen wear occurs as a consequence of speed differences between the paper web and the wire screen surface and between the wire screen surface and the surface of the drying drums. Fabric wear due to abrasion also occurs in other industrial fabrics, for instance, in transportation belts due to dragging across stationary surfaces, in filter fabrics due to the mechanical cleaning, and in screen printing fabrics due to the movement of a squeegee across the screen surface.

The forming wire screens of state of the art papermaking machines utilize multi-ply woven fabrics. To maximize the speed of dewatering the paper, suction boxes are utilized on the wire screen underside to speed paper web dewatering by means of underpressure. The contact surfaces of the edges of these suction boxes with the forming fabric generally consist of ceramic to prevent excessive wear of the suction boxes.

Still, the underside of the multi-ply forming fabric experiences high wear due to the high manufacturing speeds, the rubbing due to the fillers added to the monofils, and the sucking effect of the papermaking machine.

Monofilaments made of nylon, for example nylon-6 or nylon-6,6, are still being used to improve the abrasion resistance of the wire screen underside. The underside of the screen is conventionally made of predominantly polyethylene terephthalate (hereinafter PET) monofilaments, which are used because of their higher dimensional stability. One tried and tested construction for the wire screen underside is that of an alternating weft in which a backing weft of a nylon monofil alternates with a backing weft of PET monofil. This results in a compromise of abrasion resistance and dimensional stability.

The higher water imbibition of nylons compared with PET leads to lengthening of the weft threads in operation of the wire screen. As a result, the wire screens are prone to the undesirable effect known as edge curling in that they curl up at the edges and no longer lie flat within the papermaking machine.

There have been numerous attempts to replace nylon monofilaments with monofilaments made of other abrasion-resistant polymers that have a low water imbibition and are deformation resistant.

One example of an alternative to nylon monofil, is monofilaments made of PET blends admixed with 10-40% of thermoplastic polyurethane (TPU) (cf. for example EP-A-387,395). Similarly, mixtures of thermoplastic polyester, such as polyethylene terephthalate isophthalate, and thermoplastic polyurethane having melting points of 200 to 230° C., have also been used (cf. for example EP-A-674,029).

The prior art further describes monofilaments having a core-sheath structure in which the sheath consists of a mixture of thermoplastic polyester having a melting point of 200 to 300° C., for example PET, and of thermoplastic elastomeric copolyetherester having selected polyetherdiol building block groups as soft segments, which likewise exhibit improved abrasion resistance (cf. for example, EP-A-735,165).

Further polyester compositions comprising crystalline thermoplastic polyester resins, polyester elastomers and sorbitan esters are known from DE 691 23 510 T2. These are notable for good moldability, in particular for good releaseability.

DE 690 07 517 T2 discloses polyester compositions comprising an aromatic polycarbonate, a polyester derived from alkanediol and benzene-dicarboxylic acids, and a polyesterurethane elastomer or a polyether imide ester elastomer. These combine improved flow properties with good mechanical properties.

It has been discovered that elastomers of comparatively low Shore hardness have better abrasion properties than elastomers of comparatively high Shore hardness. Monofilaments comprising a high fraction of elastomers are consequently more abrasion resistant. However, their disadvantage is that they are more prone to flatten in the crimping points of the warp threads and thereby reduce the fabric's permeability to water.

### SUMMARY OF THE INVENTION

It is an object of the present invention to provide a composition which can be processed into strands having excellent abrasion resistance and high dimensional stability. The strands formed from this composition exhibit little if any flattening at the crimping points when processed into a woven fabric. It has been discovered, surprisingly, strands comprising a selected polymeric composition have this unique profile of properties.

The present invention accordingly provides melt-spun strands comprising (a) a thermoplastic and elastomeric polyester copolymer including structural repeat units derived from different diols, of which one is a polyetherdiol, and (b) a thermoplastic polyester copolymer comprising structural repeat units derived from different dicarboxylic acids or their polyester-forming derivatives.

### DETAILED DESCRIPTION OF THE INVENTION

The present invention is described in detail below with reference to the various examples. Modifications to particular examples within the spirit and scope of the present invention, set forth in the appended claims, will be readily apparent to those of skill in the art.

Unless otherwise indicated, terms are to be construed in accordance with their ordinary meaning. Percent, for example, refers to weight percent, unless context indicates otherwise. Following are some exemplary definitions of terms used in this specification and the appended claims.

The term “strands” is to be understood for the purposes of this description as referring very generally to fibers of finite length (staple fibers), fibers of infinite length (filaments) and also multifilaments composed thereof, or yams secondarily spun from staple fibers. The melt-spun strands are preferably used in the form of monofilaments.

The thermoplastic and elastomeric polyester copolymer component (a) may be constructed from a wide variety of combinations of monomers, provided one diol is polyetherdiol and a further diol has no polyether units, i.e., there is at least two different diols. The copolymers in question are generally derived from mixtures of short-chain alcohols, for example aliphatic or cycloaliphatic diols having two to ten carbon atoms, and of polyetherdiols, and also from dicarboxylic acids or their polyester-forming derivatives, such as dicarboxylic esters or dicarbonyl chlorides, which have aliphatic, cycloaliphatic and/or aromatic groups.

For the purposes of this description, a thermoplastic and elastomeric copolyester (a) is a copolyester which has a similar room temperature behavior to conventional elastomers, but is plastically deformable on heating and thus exhibits a thermoplastic behavior. These thermoplastic and elastomeric copolyesters have sub-regions with physical points of crosslinking (for example, secondary valency forces or crystallites) which become unlinked on heating without the polymer molecules decomposing. These copolyesters are block copolyesters having hard and soft segments within any one molecule.

These thermoplastic and elastomeric polyether copolyesters are known per se. Examples thereof are copolyesters which, in addition to one or more of (i) polyethylene terephthalate, polycyclohexanedimethyl terephthalate, polyethylene naphthalate or particularly polybutylene terephthalate units, comprise further units derived from one or more of (ii) aromatic and/or aliphatic and/or cycloaliphatic dicarboxylic acids, in particular from adipic acid, sebacic acid, terephthalic acid, cyclohexanedicarboxylic acid or isophthalic acid, and from (iii) polyalkylene glycols, particularly polyethylene glycols.

Building blocks of thermoplastic and elastomeric copolyesters (a) are preferably diols, polyetherdiols and dicarboxylic acids, or correspondingly constructed polyester-forming derivatives. The main acid constituent of the copolyesters comprises terephthalic acid or cyclohexanedicarboxylic acid, but other aromatic and/or aliphatic or cycloaliphatic dicarboxylic acids may also be suitable, preferably para- or trans-disposed aromatic compounds, for example 2,6-naphthalenedicarboxylic acid or 4,4′-biphenyldicarboxylic acid, and also isophthalic acid. Aliphatic dicarboxylic acids, such as adipic acid or sebacic acid for example, are preferably used in combination with aromatic dicarboxylic acids.

Useful dihydric alcohols typically include aliphatic and/or cycloaliphatic diols, for example ethylene glycol, propanediol, 1,4-butanediol, 1,4-cyclohexane-dimethanol or mixtures thereof. Preference is given to aliphatic diols having two to four carbon atoms, particularly ethylene glycol and butanediol. Preference is further given to cycloaliphatic diols, such as 1,4-cyclohexanedimethanol. These dihydric alcohols combine with the dicarboxylic acid units to form the hard segments of the thermoplastic and elastomeric copolyester (a). The soft segments of this copolyester are formed by structural repeat units derived from polyetherdiols and dicarboxylic acids. The polyetherdiols typically comprise polyalkylene glycols, such as polyethylene glycol, polypropylene glycol or polybutylene glycol.

Preference for use as component (a) is given to copolyesters comprising structural repeat units derived from an aromatic dicarboxylic acid and an aliphatic diol and also from a polyalkylene glycol.

Preferred thermoplastic and elastomeric copolyesters (a) have structural repeat units derived from one or more of the following groups: terephthalic acid, ethylene glycol and polyethylene glycol; or from terephthalic acid, butylene glycol and polyethylene glycol; or from terephthalic acid, butylene glycol and polybutylene glycol; or from naphthalenedicarboxylic acid, ethylene glycol and polyethylene glycol; or from naphthalenedicarboxylic acid, butylene glycol and polyethylene glycol; or from naphthalenedicarboxylic acid, butylene glycol and polybutylene glycol; or from terephthalic acid, isophthalic acid, ethylene glycol and polyethylene glycol; or from terephthalic acid, isophthalic acid, butylene glycol and polyethylene glycol; or from terephthalic acid, isophthalic acid, butylene glycol and polybutylene glycol.

Any fiber-forming thermoplastic polyester copolymer can be used in the invention for component (b). The copolymer in question will generally comprise polymers derived from alcohols and dicarboxylic acids or their polyester-forming derivatives, such as dicarboxylic esters or dicarbonyl chlorides, which have aliphatic and/or cycloaliphatic and/or aromatic groups. These copolyesters generally do not contain any combinations of hard and soft segments. In this regard, they generally do not contain any building block groups derived from polyetherdiols.

The thermoplastic copolyesters are known per se. Building blocks of thermoplastic copolyesters (b) are preferably diols and dicarboxylic acids or appropriately constructed polyester-forming derivatives. The main acid constituent of the polyesters is terephthalic acid or cyclohexanedicarboxylic acid together with other aromatic and/or aliphatic or cycloaliphatic dicarboxylic acids, preferably with para- or trans-disposed aromatic compounds, for example 2,6-naphthalenedicarboxylic acid or 4,4′-biphenyldicarboxylic acid, and also preferably with isophthalic acid and/or with aliphatic dicarboxylic acids, for example with adipic acid or sebacic acid.

Useful dihydric alcohols typically include aliphatic and/or cycloaliphatic diols, for example ethylene glycol, propanediol, 1,4-butanediol, 1,4-cyclohexane-dimethanol or mixtures thereof. Preference is given to aliphatic diols having two to four carbon atoms, particularly ethylene glycol and butanediol. Preference is further given to cycloaliphatic diols, such as 1,4-cyclohexanedimethanol.

Examples of preferred components (b) are copolyesters which as well as (i) polybutylene terephthalate, polycyclohexanedimethyl terephthalate, polyethylene naphthalate or particularly polyethylene terephthalate units, comprise further units derived from (ii) alkylene glycols, in particular ethylene glycol, and units derived from (iii) aliphatic and/or aromatic dicarboxylic acids, such as adipic acid, sebacic acid or isophthalic acid.

Particularly preferred components (b) are copolyesters as well as structural repeat units of polyalkylene terephthalate comprising structural repeat units of polyalkylene adipate, of polyalkylene sebacate or particularly of polyalkylene isophthalate.

Very particularly preferred components (b) are copolyesters which have structural repeating units of polyethylene terephthalate which also includes structural repeating units of polyethylene adipate, of polyethylene sebacate or more particularly of polyethylene isophthalate.

The fraction of the strand according to the present invention which is contributed by the second acid component, preferably by isophthalic acid, is typically up to 25% by weight, based on the weight of the copolyester, preferably between 0.1% by weight and 20% by weight and more preferably between 8% by weight and 12% by weight.

The amounts of components (a) and (b) in the fibers of the present invention can be chosen within wide ranges. The fibers typically contain 10% to 90% by weight of component (a) and 90% to 10% by weight of component (b), all based on the total mass of the fiber.

The component (b) content of the total mass of the strand is preferably between 40% and 95% by weight, more preferably between 50% and 85% by weight and most preferably between 65% and 75% by weight. Likewise, the component (a) content of the total mass fo the strand is preferably between 5% and 60% by weight, more preferably from 15% to 50% by weight, and most preferably from 25% to 35% by weight.

Further, particularly preferred strands contain a polyether polyester as component (a) having a Shore hardness D of 35 to 90, preferably of 35 to 45.

Still further, particularly preferred strands have a free thermal shrinkage at 160° C. of less than 6%.

In addition to components (a) and (b), the fiber of the present invention may additionally comprise further fiber-forming thermoplastic polymers (c), such as polyester, for example PET, and/or polyamides. The fraction of this component (c) is generally low and should not exceed 10% by weight, based on the total mass of the fiber.

The polyesters used according to the present invention for components (a) and (b) typically have solution viscosities (IV values) of at least 0.60 dl/g, preferably of 0.60 to 1.05 dl/g, and more preferably of 0.62-0.93 dl/g (measured at 25° C. in dichloroacetic acid (DCE)).

Preference is given to strands of polyesters having a free carboxyl group content of not more than 3 meq/kg.

These preferably comprise an agent for capping free carboxyl groups, for example a carbodiimide and/or an epoxy compound.

Polyester strands thus endowed are stabilized to hydrolytic degradation and are particularly suitable for use in hot moist environments, especially in papermaking machines or as filters.

The combination of polyesters (a) and (b) which is used according to the present invention endows the polyester strands with an excellent abrasion resistance without adverse effect on their dynamic properties or their dimensional stability.

The components (a) and (b) required for producing the strands of the present invention are known per se, partly commercially available or obtainable by processes known per se.

The strands of the present invention, as well as components (a), (b) and if appropriate (c), may further comprise further, auxiliary chemical species (d).

Examples of component (d) include, in addition to the aforementioned hydrolysis stabilizer, processing aids, antioxidants, plasticizers, lubricants, pigments, delusterants, viscosity modifiers or crystallization accelerants.

Examples of processing aids include siloxanes, waxes or comparatively long-chain carboxylic acids or their salts, aliphatic, aromatic esters or ethers.

Examples of antioxidants include phosphorus compounds, such as phosphoric esters or sterically hindered phenols.

Examples of pigments or delusterants include organic dye pigments or titanium dioxide.

Examples of viscosity modifiers include polybasic carboxylic acids and their esters or polyhydric alcohols.

The strands of the present invention can be present in any desired form, for example as multifilaments, as staple fibers, as secondarily spun yams, including in the form of threads, or particularly as monofilaments.

The linear density of the strands according to the present invention can vary within wide limits. Examples thereof are 1 to 45 000 dtex and especially 100 to 4000 dtex.

The cross-sectional shape of the strands according to the present invention is not limited, examples being round, oval or n-gonal, where n is not less than 3.

The strands of the present invention are obtainable by processes known per se.

The present invention also provides a process for producing the above-defined strands comprising the measures of:
i) extruding a mixture comprising components (a) and (b) through a spinneret die,
ii) withdrawing the resulting filament, and
iii) if appropriate drawing and/or relaxing the resulting filament.

Preferably, the strands of the present invention are restricted to single or multiple drawing in the course of their process of production.

It is particularly preferable to produce the strands using as component (a) and/or (b) a polyester produced by solid state condensation.

After the polymer melt has been forced through a spinneret die, the hot strand of polymer is quenched, for example in a quench bath, preferably in a water bath, and subsequently wound up or withdrawn. The withdrawal speed is greater than the ejection speed of the polymer melt.

The strand thus produced is subsequently preferably subjected to an after-drawing operation, to an overall draw ratio in the range from 3:1 to 8:1 and preferably in the range from 4:1 to 6:1. The afterdrawing operation preferably occurs in a plurality of stages, particularly to a two- or three-stage afterdrawing operation.

Drawing is preferably followed by heat setting, for which temperatures in the range from 130 to 280° C. are employed. During setting, strand length may be maintained constant, slight afterdrawing may be effected, or shrinkage of up to 30% may be allowed, for example.

It has been determined to be particularly advantageous for the production of the strands of the present invention to operate at a melt temperature in the range from 230 to 280° C. and at a jet stretch ratio in the range from 2:1 to 6:1.

The withdrawal speed is customarily 10-80 m per minute.

The strands of the present invention are preferably used for producing textile fabrics, particularly woven fabrics, spiral fabrics, nonwoven scrims or drawn-loop knits. These textile fabrics are preferably used in screens.

Textile fabrics comprising the strands of the present invention likewise form part of the subject matter of this invention.

Particular preference is given to woven fabrics which as well as the strands comprising components (a) and (b) comprise further strands of other polyester, for example PET strands.

The strands of the present invention can be used in all industrial fields. They are preferably employed for applications where increased wear due to mechanical stress is likely. Examples thereof are the use in screens or in conveyor belts. These uses likewise form part of the subject matter of the present invention.

A further use of the strands of the present invention in the form of monofilaments concerns their use as conveyor belts or as components of conveyor belts.

Particular preference is given to uses for the strands of the present invention in screens which are wire screens and intended for use in the forming section of papermaking machines.

These uses likewise form part of the subject matter of the present invention.

The examples which follow elucidate the invention without limiting it in any regard.

### EXAMPLES

Nine identical woven fabric constructions were used in each case. All cases utilized 0.22 mm diameter monofilaments in the backing weft which, however, differed in the material used. The polyester types used were commercially available material.

The following woven fabrics were produced:
Fabric 1 (comparison): backing weft of alternating PET and N6 monofils (alternating weft)
Fabric 2 (comparison): backing weft just of PET monofils (Type 900 S¹)
Fabric 3: 900 DQ² (monofil of 80% isophthalic acid modified PET³ and 20% thermoplastic polyester elastomer⁴)
Fabric 4: 900 DQ² (monofil of 75% isophthalic acid modified PET³ and 25% thermoplastic polyester elastomer⁴)
Fabric 5: 900 DQ² (monofil of 70% isophthalic acid modified PET³ and 30% thermoplastic polyester elastomer⁴)
Fabric 6: 900 DQ² (monofil of 65% isophthalic acid modified PET³ and 35% thermoplastic polyester elastomer⁴)
Fabric 7: 900 DQ² (monofil of 60% isophthalic acid modified PET³ and 40% thermoplastic polyester elastomer⁴)
Fabric 8 (comparison): 900 RQ² (monofil of 75% PET and 25% thermoplastic polyester elastomer⁵)
Fabric 9 (comparison): 900 RQ² (monofil of 70% PET and 30% thermoplastic polyester elastomer⁵)
   ¹Type 900 characterizes low shrinkage polyester types
   ²The type designations come from the nomenclature of the commercial types from Teijin Monofilament Germany GmbH; type 900 characterizes low shrinkage polyester types, the subsequent first letter is for the base polymer; S is for PET Standard, R is for PET with <10 meq COOH groups/kg of polyester and D is for PET copolymer with about 10% isophthalic acid modified (IPA-modified PET); the second letter identifies an additive, where Q is for a polyether polyester of the Riteflex® type (commercial product from Ticona GmbH (??))
   ³With about 10% isophthalic acid modified PET copolymer
   ⁴Riteflex® 640 having Shore D hardness of 40
   ⁵Riteflex 655 having Shore hardness D of 55

The fabrics were set under identical conditions, cut into narrow strips and tested in an AT 2000 Einlehner with a ceramic-bars rotator operating at the following conditions/settings:
fabric strip: 148 mm * 25.8 mm
Machine side of fabric (underside) on ceramic-strip rotator (width 22.6 mm)
Pre-tension: 2 kN
Suspension: 1000 ml of water +8 g of calcium carbonate (Millicarb 45 OG)+14 mg of Polysalt S dispersing assistant (to obtain a very finely divided pigment suspension of the calcium carbonate)
Suspension temperature: a constant 50° C.
Trip distance: 25 km

The relative weight loss of the samples was determined. The results are listed below in the table (“C” denotes comparative; “I” denotes inventive).

| Fabric No. | Weight loss (%) |
|---|---|
| 1 (C) | 4.3 |
| 2 (C) | 15.9 |
| 3 (I) | 6.8 |
| 4 (I) | 4.0 |
| 5 (I) | 4.1 |
| 6 (I) | 3.2 |
| 7 (I) | 1.9 |
| 8 (C) | 6.4 |
| 9 (C) | 9.5 |

The weight loss of fabric 1 (alternating weft) is to be regarded as standard. Fabric 2 with the all PET backing weft exhibited the low abrasion resistance which PET has compared with the alternating weft.

Fabrics 8 and 9 contain the polyether ester of higher hardness as a blend in PET. Abrasion was higher here than for the standard. By contrast, the polyether ester of lower Shore hardness, which moreover was additionally present in the mixture with a copolyester of PET with isophthalic acid, exhibited substantially more abrasion resistance. Particularly the high addition rates of 35%-40% improved the abrasion resistance of these fabric samples (fabrics 6 and 7) significantly compared with the standard (fabric 1). Experience shows that fabric samples 4 and 5 at 25% to 30% by weight constitute the best compromise between flattening (water permeability of final fabric) and abrasion resistance.

While the invention has been described in connection with several examples, modifications to these examples within the spirit and scope of the invention will be readily apparent to those of skill in the art. In view of the foregoing discussion, relevant knowledge in the art and references discussed above in connection with the Background and Detailed Description, the disclosures of which are all incorporated herein by reference, further description is deemed unnecessary.

What is claimed is:

1. A melt-spun strand comprising (a) a thermoplastic and elastomeric polyester copolymer including structural repeat units derived from at least two different diols, of which one is a polyetherdiol, and (b) a thermoplastic polyester copolymer comprising structural repeat units derived from at least two different dicarboxylic acids or their polyester-forming derivatives.

2. The melt-spun strand according to claim 1, wherein component (a) is a copolyester having structural repeat units derived from an aromatic dicarboxylic acid, from an aliphatic diol, and from a polyalkylene glycol.

3. The melt-spun strand according to claim 2, wherein component (a) comprises structural repeat units derived from one or more of the following groups: (i) terephthalic acid, ethylene glycol and polyethylene glycol; (ii) terephthalic acid, butylene glycol and polyethylene glycol; (iii) terephthalic acid, butylene glycol and polybutylene glycol; (iv) naphthalenedicarboxylic acid, ethylene glycol and polyethylene glycol; (v) naphthalenedicarboxylic acid, butylene glycol and polyethylene glycol; (vi) naphthalenedicarboxylic acid, butylene glycol and polybutylene glycol; (vii) terephthalic acid, isophthalic acid, ethylene glycol and polyethylene glycol; (viii) terephthalic acid, isophthalic acid, butylene glycol and polyethylene glycol; (ix) terephthalic acid, isophthalic acid, butylene glycol and polybutylene glycol.

4. The melt-spun strand according to claim 1, wherein component (b) is a copolyester which includes units of at least one of (i) polybutylene terephthalate, polycyclohexanedimethyl terephthalate, polyethylene naphthalate, and polyethylene terephthalate units; and units derived from a least one of (ii) alkylene glycols, ethylene glycol, aliphatic and/or aromatic dicarboxylic acids; and further includes units derived form at least one of (iii) adipic acid, sebacic acid, and isophthalic acid.

5. The melt-spun strand according to claim 4, wherein component (b) is a copolyester which includes structural repeat units of polyalkylene terephthalate, and structural repeat units of at least one of polyalkylene adipate, polyalkylene sebacate, and polyalkylene isophthalate.

6. The melt-spun strand according to claim 5, wherein component (b) is a copolyester which includes structural repeat units of polyethylene terephthalate, and structural repeat units of at least one of polyethylene adipate, polyethylene sebacate, and polyethylene isophthalate.

7. The melt-spun strand according to claim 1, wherein one of the dicarboxylic acids is present in component (b) in amounts of between 0. 1% by weight and 20% by weight based on the weight of the copolyester.

8. The melt-spun strand according to claim 1, wherein isophthalic acid is present in component (b) in amounts of from 8% by weight and 12% by weight, based on the weight of the copolyester.

9. The melt-spun strand according to claim 1, wherein the strand includes from 40% to 95% by weight of component (b) based on the total weight of the strand.

10. The melt-spun strand according to claim 1, wherein the strand includes from 50% to 85% by weight of component (b) based on the total weight of the strand.

11. The melt-spun strand according to claim 1, wherein the strand includes from 65% to 75% by weight of component (b) based on the total weight of the strand.

12. The melt-spun strand according to claim 1, wherein the thermoplastic and elastomeric polyester copolymer (a) has a Shore hardness D in the range from 35 to 90 and preferably in the range from 35 to 45.

13. The melt-spun strand according to claim 1, wherein the strand is a secondarily spun strand from melt-spun fiber and is either a multifilament or a monofilament.

14. The melt-spun strand according to claim 1, wherein the strand is a monofilament.

15. The melt-spun strand according to claim 1, wherein the strand exhibits a free thermal shrinkage at 160° C. that is less than 6%.

16. A woven textile fabric, comprising a plurality of the strands of claim 1.

17. The woven fabric according to claim 16 which, in addition to strands comprising components (a) and (b), further comprise strands of another polyester.

18. The woven fabric according to claim 17, wherein the fabric further comprises strands of polyethylene terephthalate.

19. The use of a melt-spun strand of claim 1 in textile fabrics for papermaking machine fabrics.

20. The use of a melt-spun strand of claim 1 in textile fabrics for filter fabrics.

21. The use of a melt-spun strand of claim 1 in textile fabrics for conveyor belt fabrics.

22. The use of the melt-spun strand of claim 1 as a backing weft in the forming fabric of a papermaking machine.

23. A process for producing a melt-spun strand, said process comprising the steps of:
i) extruding a polymeric mixture through a spinneret die, where the mixture includes (a) a thermoplastic and elastomeric polyester copolymer comprising structural repeat units derived from at least two different diols, of which one is a polyetherdiol, and (b) a thermoplastic polyester copolymer comprising structural repeat units derived from at least two different dicarboxylic acids or their polyester-forming derivatives;
ii) withdrawing the resulting filament; and
iii) optionally, drawing and/or relaxing the resulting filament.
